(19) United States
(12) Patent Application Publication
(10) Pub. No.: US 2006/0086651 A1
(43) Pub. Date: Apr. 27, 2006

(54) Internal recycle process for HOG waste

(76) Inventor: Larry P. Sower, Milford, UT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/973,104

(22) Filed: Oct. 25, 2004

(51) Int. Cl. C02F 1/00

(52) U.S. Cl. 210/173; 210/195.1; 210/209

(57) ABSTRACT

An animal waste management system for handling a waste slurry that includes coarse solids flushed from an animal confinement housing. The system comprises a surge tank for stabilizing the flow of waste slurry through the waste management system, reducing means for reducing the particle size of the coarse solids contained within the waste slurry flushed from the animal confinement housing, recycling means for recycling a portion of the waste slurry through the waste management system at a recycle rate so as to increase the concentration of solids within the waste slurry flushed from the animal confinement housing, and conditioning means for conditioning at least the recycled portion of the waste slurry to maintain air quality in the animal confinement housing.

### BACKGROUND OF THE INVENTION

1. The Field of the Invention

The present invention relates in general to an animal waste management system and method thereof and more particularly to a hog waste management system and method thereof for waste management systems which provide for continuous recycling of animal waste slurry such that a highly concentrated waste slurry is produced.

2. The Relevant Technology

Two of the primary systems used in the hog industry to remove animal waste from animal confinement barns are the high volume flush system and pull plug system. In high volume flush systems, the water introduced for livestock watering, cleaning, and cooling mixes with solid waste from the animals to produce a waste slurry. Without dilution, the slurry concentration generated by hogs ranges from about 3% to 9% total solids depending upon water management practices used by the hog producer. Designed to improve air quality in the confinement barns and to convey manure slurry from the barns, the high volume flush system intentionally dilutes the waste slurry with recycled surface water from large ambient temperature anaerobic lagoons or other downstream treatment/storage units so that the waste slurry flushed from the barns contains typically less than 0.5% total solids. In pull plug systems, a large volume of pit recharge water is recycled in a similar fashion for similar reasons so that the waste slurry again contains less total solids (typically 0.5% to 2%) when flushed from the barns.

A problem associated with ambient temperature anaerobic lagoon systems is the accumulation of soluble salts. Long term storage and recycling of lagoon wastewater allows the accumulated liquor to reach saturation in sparingly soluble salts, primarily struvite (magnesium ammonium phosphate). These salts deposit in recycle and recharge pumps and piping systems and require routine removal for proper system operation. The removal of the accumulated salts in conventional systems is very costly. In systems where the problem becomes chronic, the system is often reconfigured to provide two parallel systems so that one can be operated while the other is cleaned with acid to remove the salt deposits.

Flush systems and pull plug systems use relatively large volumes of dilute recycle/recharge wastewater from down stream treatment/storage processes to convey waste. Thus the flow rates from confinement buildings using these existing technologies are as much as 30 times higher than the actual slurry production rate of the animals. This low concentration of waste slurry causes prohibitively high capital and operating costs when attempting to retrofit these systems with advanced waste treatment technology. Advanced waste treatment technologies include but are not limited to anaerobic digestion gasification and chemical processing to produce commercially valuable fertilizer, fuel, or other products. The factors resulting in high operating and capital costs include but are not limited to the need for large vessel sizes, slurry temperature loss and high pump volumes. The only viable alternative to alleviate these problems is to modify existing barns with alternative waste collection systems, which has been prohibitively expensive.

Accordingly, it would be an improvement in the art to provide an animal waste management system that does not rely on large anaerobic lagoons, that would reduce the volume of waste to be treated, and that could be used to produce a fertilizer product, all without being prohibitively expensive.

### BRIEF SUMMARY OF THE INVENTION

An animal waste management system for handling a waste slurry that includes coarse solids flushed from an animal confinement housing at a flush rate is disclosed. The system comprises a surge tank for stabilizing the flow of waste slurry through the waste management system, reducing means for reducing the particle size of the coarse solids contained within the waste slurry flushed from the animal confinement housing, recycling means for recycling a portion of the waste slurry through the waste management system at a recycle rate so as to increase the concentration of solids within the waste slurry flushed from the animal confinement housing, and conditioning means for conditioning at least the recycled portion of the waste slurry to maintain air quality in the animal confinement housing.

According to one embodiment, the reducing means comprises a grinder pump, a chopper pump, or both. The coarse solids in the waste stream often include corn hulls, grain, hair, and other stringy or fibrous materials. Grinder and/or chopper pumps mash, grind, and chop this material to produce a waste stream emulsion which is more easily handled with less cost and less maintenance than a separated waste stream as produced, for example, by screening. In addition, producing a waste stream emulsion eliminates the need for separating the waste slurry, e.g., by natural gravity sedimentation.

The recycling means may comprise a recycle pump (e.g., a chopper pump), and a controller in communication with the recycle pump, the controller being adapted to stop operation of the recycle pump when the level of waste slurry within the surge tank reaches a predetermined level, whereby failure of the recycle pump is prevented.

The conditioning means may comprise an aerator to aerate at least the recycled portion of the waste slurry to prevent the formation of hydrogen sulfide, and a regulator adapted to regulate the pH of at least the recycled portion of the waste slurry to prevent the emission of excess ammonia.

A method for managing a waste produced from an animal confinement housing with a waste management system is also disclosed. The method comprises the steps of flushing the waste from the animal confinement housing with a flushing material at a flush rate to produce a waste slurry including coarse solids, reducing the particle size of the coarse solids within the waste slurry to produce a coarse solids-free waste slurry, removing a volume of coarse solids-free waste slurry to produce a remaining volume of waste slurry, continuously recycling a portion of the waste slurry through the waste management system at a recycle rate which is preferably at least 95% of the flush rate so that the removed volume of waste slurry has a high concentration of solids, and conditioning at least the recycled portion of the waste slurry to maintain air quality in the animal confinement housing.

The step of reducing the particle size of the coarse solids of the waste slurry may comprise chopping and/or grinding the waste slurry.

The step of conditioning may comprise the steps of aerating at least the recycled portion of the waste slurry to prevent the formation of hydrogen sulfide, and adjusting the pH of at least the recycled portion of the waste slurry to prevent the emission of ammonia.

These and other benefits, advantages and features of the present invention will become more fully apparent from the following description and appended claims, or may be learned by the practice of the invention as set forth hereinafter.

### BRIEF DESCRIPTION OF THE DRAWINGS

In order that the manner in which the above recited and other benefits, advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 is a schematic view of a conventional flush system for the removal of animal waste from an animal confinement barn; and

FIG. 2 is a schematic view of one embodiment of an animal waste management system according to the present invention.

### DETAILED DESCRIPTION OF THE PREFERRED EMBODIMENTS

I. Introduction

A detailed description of the invention will now be provided with specific reference to Figures illustrating preferred embodiments of the invention. It will be appreciated that like structures will be provided with like reference designations.

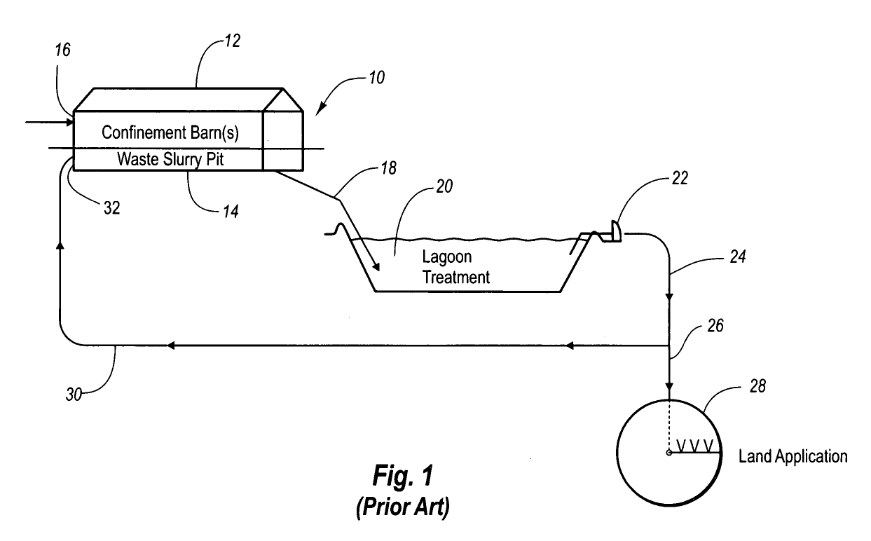

FIG. 1 illustrates a conventional high flush waste removal system. The removal system, generally designated 10, includes a confinement structure or barn 12, having waste slurry pits 14. Fresh water is piped in through fresh water inlet 16, mixes with recycled lagoon water 30, discussed below, and washes through the slurry pits 14. The result is a waste slurry, typically having about 0.5% total solids. The waste slurry is then directed through piping 18 into a lagoon 20.

A typical 8000 head grow/finish farm requires a 2-5 acre lagoon, depending on regional climate, use or disposal of treated waste, seasonal storage requirements, and demands of regulatory permits. Water is removed from lagoon 20 by pump 22 to be recycled by piping 24 and 30 back to the barn 12 through inlet 32 for further waste removal. Additionally, the diluted slurry may be diverted through piping 26 for land application 28.

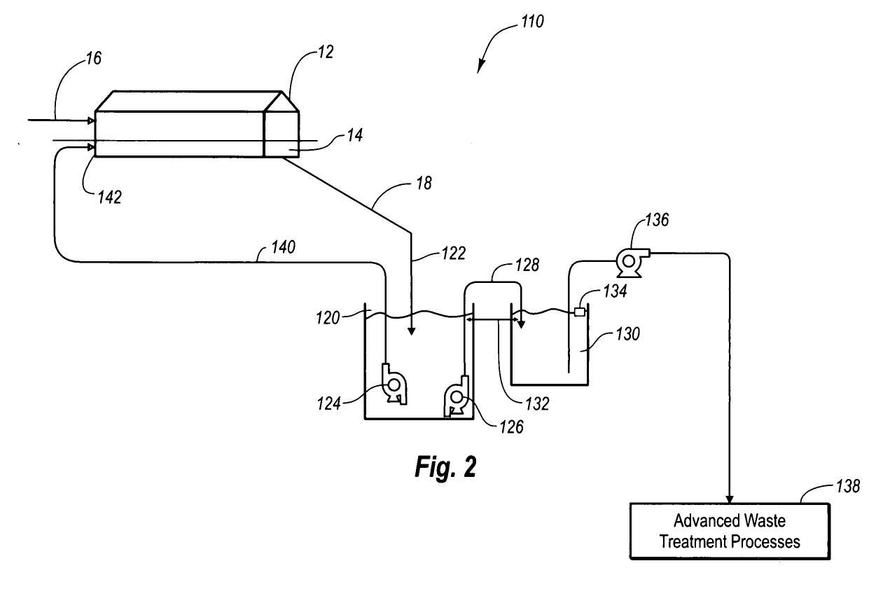

Referring now to FIG. 2, there is provided an exemplary embodiment of an animal waste management system of the present invention. The waste management system, also known as an internal recirculation system, is described in connection with an 8000 head hog animal confinement facility for illustration purposes only, as the system can be utilized with any size facility and for any livestock producing waste. While a preferred system is shown retrofitted onto an existing high flush waste management system, it can be appreciated by one skilled in the art that the system can also be adapted for use in a newly constructed facility.

The hog waste management system 110 of FIG. 2 is illustrated in conjunction with an animal confinement housing 12 such as a barn, having a waste removal system including waste slurry pits 14. The flow of fresh water 16, preferably at a rate of about 15 gallons per minute (gpm), is provided to water, clean and cool the livestock. A mixture of the fresh water 16, and recycled waste slurry 140, which enters the system at 142, as discussed below, is combined to wash the animal waste products from the slurry pits 14, preferably at a rate of approximately 400 gpm. The resulting effluent is hereafter designated the waste slurry.

The waste slurry is directed through piping 18 and received into a wet well or surge tank 120 through surge tank inlet 122. The surge tank 120 acts to stabilize the system flow. A minimum 12-hour capacity, as calculated from the fresh water input (e.g., 15 gpm) is preferred for the surge tank 120.

Chopper pump 124 and grinder pump 126 act to reduce the particle size of the coarse solids contained within the waste slurry, thereby preventing clogging of system 110. It can be appreciated, however, that other components and methods may be used as reducing means for reducing the particle size of the coarse solids, including but not limited to crushing the coarse solids or using ultrasonic technologies for reducing particle size.

According to the embodiment illustrated in FIG. 2, chopper pump 124 is located within surge tank 120. The waste slurry passing through chopper pump 124 is pumped out of surge tank 120 and recycled for use in flushing animal confinement housing 12. The chopper pump is operated at the recycle flow rate, for example, 385 gpm.

According to the embodiment illustrated in FIG. 2, grinder pump 126 may be located on or near the bottom of surge tank 120. The waste slurry passing through grinder pump 126 is removed from surge tank 120 through piping 128 and into slurry tank 130. According to one embodiment, grinder pump 126 may operate at about 300 gpm.

According to the illustrated embodiment, slurry tank 130 is connected by overflow piping 132 to surge tank 120. In normal operation, the waste slurry within slurry tank 130 overflows into surge tank 120 when the level of waste slurry within the slurry tank reaches a predetermined level. This allows the waste slurry to pass again through chopper pump 124 and/or grinder pump 126 so as to effectively reduce the particle size of coarse solids contained within the waste slurry.

Slurry tank 130 preferably includes a level control 134. When the level of the waste slurry in tank 130 reaches a preset level as determined by level control 134, slurry tank outlet valve or pump 136 removes the coarse solids-free waste slurry at a rate roughly equivalent to the volume of fresh water input to the animal confinement housing 12, for example, about 15 gpm. With such a configuration, the hydraulic equilibrium of system 110 is maintained. The removed waste slurry preferably includes a solids content of about 4-8%, while being free of coarse solids. In systems where water conservation equipment is used, for example swinging waterers to reduce animal spillage, the total solids concentration can reach 11% with animals nearing market weight.

The resulting concentrated waste slurry, typically 4-8% total solids, may be advanced to one or more advanced treatment facilities 138 which may include chemical, biological, and thermal process technologies to produce methane, fertilizers, animal feeds, liquid fuels, waste incineration, inorganic products and additional organic products.

Prior to introducing the recycled waste slurry through piping 140 into the animal confinement housing 12 for flushing, any required conditioning of the waste slurry may be performed. Conditioning the waste slurry helps to maintain the air quality in the animal confinement housing. According to one embodiment, aeration, pH regulation, or other necessary processes may be carried out in surge tank 120. According to an alternative embodiment, any necessary conditioning may be carried out in a separate conditioning tank (not shown). The degree of waste slurry conditioning required is determined in part by air quality considerations within the animal confinement housing 12. Partial aeration of the waste slurry is used to prevent the formation of hydrogen sulfide. Under normal circumstances, the formation of hydrogen sulfide should not be a problem, as the fluid should be no more than a few hours old at any one time, and the open tank discharges of the recycling system inherently provide partial aeration of the waste slurry. This results in an air quality in the animal confinement area which is at least as good as conventional flush systems, and is a significant improvement over other conventional methods.

The pH of at least the recycled portion of waste slurry must be maintained below a pH of about 8.0, but preferably in the range of about pH 7.5-8.0 to avoid the emission of excess ammonia. The pH may be regulated by the addition of acid to the waste slurry in surge tank 120, or by addition of acid to a separate conditioning tank (not shown). While sulfuric acid may be preferred in some embodiments because of its low cost and the lack of formation of secondary products, any industrial or organic acid may be used. The use of organic acids such as citric acid or CO₂ (i.e., carbonic acid) may be preferred in some embodiments where the method and/or product is to be organically certifiable.

Surge tank 120, slurry tank 130, and any additional tanks (e.g., a conditioning tank) preferably include level indicators to protect the pumping system without constant human monitoring. The level indicators are configured so that in the event that the slurry level in a tank drops to a level at which any pump could be damaged by inadequate flow, the pumping system is automatically shut down.

The conditioned recycle slurry is advanced through chopper pump 124 and piping 140 connected between chopper pump 124 and barn 12. The conditioned recycle slurry is pumped at a rate which, when combined with fresh water 16, provides the necessary flow required by system 110. In this case, the approximately 400 gpm required by system 110 is met by about 15 gpm of fresh water 16 and about 385 gpm of recycled conditioned waste slurry from the surge tank 130 and chopper pump 124.

From the foregoing description those skilled in the art will appreciate that the animal waste management system of the present invention provides an end product waste slurry which is consistent, easy to pump and of the concentration required for the slurry to be processed by advanced waste treatment technologies. The total volume of water and size of containment vessels needed to operate the flush system are at the same time significantly reduced. Further, the waste system of the present invention can be easily and economically retrofitted onto existing high volume flush or pull plug systems. Under optimum conditions, the system can decrease effluent volume by up to 30 times. In addition, problems due to salt accumulation are virtually eliminated. When used as a stand alone system, the present invention requires reduced capital and operating costs.

The invention provides the livestock industry access to advanced waste treatment technologies previously unavailable due to the high volumes of dilute waste produced by existing practices. Also, the waste slurry can be treated during recycling to control any potential degradation of air quality in the animal confinement barns. Finally, the system inherently requires little human oversight, due to the constant flow system and level indicator pump protection within the tanks.

While a specific embodiment has been shown and described, many variations are possible. While the waste removal system has been described in connection with hog farming, the system is applicable to waste removal from other types of animal or livestock facilities, including but not limited to poultry, cattle and sheep, with few if any modifications.

Also, while the system of the present invention has been illustrated for use with high flush systems, the present invention could also be retrofit onto other conventional waste removal systems, including pull plug systems.

Finally, although direct coupling of the recycling system of the present invention to advanced processing facilities obviates the need for a lagoon, the present system can be coupled to an ambient temperature anaerobic lagoon if desired. Farm odors would be reduced by decreasing lagoon loadings, reduced odors from the confinement housing and decreased land application of liquid waste.

It will also be appreciated that the present claimed invention may be embodied in other specific forms without departing from its spirit or essential characteristics. The described embodiments are to be considered in all respects only as illustrative, not restrictive. The scope of the invention is, therefore, indicated by the appended claims rather than by the foregoing description. All changes that come within the meaning and range of equivalency of the claims are to be embraced within their scope.

What is claimed is:

1. An animal waste management system for handling a waste slurry that includes coarse solids flushed from an animal confinement housing at a flush rate, comprising:
a surge tank for stabilizing the flow of waste slurry through the waste management system;
reducing means for reducing particle size of coarse solids contained within the waste slurry flushed from the animal confinement housing;
recycling means for recycling a portion of the waste slurry through the waste management system at a recycle rate, so as to increase the concentration of solids within the waste slurry flushed from the animal confinement housing; and
conditioning means for conditioning at least the recycled portion of the waste slurry to maintain air quality in the animal confinement housing.

2. An animal waste management system as recited in claim 1, wherein the reducing means comprises a chopper pump and/or a grinder pump.

3. An animal waste management system as recited in claim 1, wherein the recycling means comprises a recycle pump, and a controller in communication with the recycle pump, the controller being adapted to stop operation of the recycle pump when the level of waste slurry within the surge tank reaches a predetermined level, whereby failure of the recycle pump is prevented.

4. An animal waste management system as recited in claim 3, wherein the recycle pump comprises a chopper pump.

5. An animal waste management system as recited in claim 1, wherein the conditioning means comprises:
an aerator to aerate at least the recycled portion of the waste slurry to prevent the formation of hydrogen sulfide; and
a regulator adapted to regulate the pH of at least the recycled portion of the waste slurry to prevent the emission of excess ammonia.

6. An animal waste management system as recited in claim 1, wherein the recycle rate is at least about 95% of the flush rate.

7. An animal waste management system as recited in claim 1, wherein the amount of solids in the waste slurry flushed from the animal confinement housing is between about 4% and about 8%.

8. An animal waste management system for handling a waste slurry that includes coarse solids flushed from an animal confinement housing at a flush rate, comprising:
a surge tank for stabilizing the flow of waste slurry through the waste management system;
at least one of a chopper pump and a grinder pump for reducing particle size of coarse solids contained within the waste slurry flushed from the animal confinement housing;
a recycle pump for recycling a portion of the waste slurry through the waste management system at a recycle rate, so as to increase the concentration of solids within the waste slurry flushed from the animal confinement housing;
an aerator to aerate at least the recycled portion of the waste slurry to prevent the formation of hydrogen sulfide; and
a regulator adapted to regulate the pH of at least the recycled portion of the waste slurry to prevent the emission of excess ammonia.

9. An animal waste management system as recited in claim 8, wherein the chopper pump and the grinder pump are situated inside the surge tank.

10. An animal waste management system as recited in claim 9, wherein the grinder pump is located below the chopper pump.

11. An animal waste management system as recited in claim 8, wherein the recycle pump comprises the chopper pump.

12. An animal waste management system as recited in claim 8, further comprising a slurry tank fed by the grinder pump.

13. An animal waste management system as recited in claim 12, further comprising overflow piping connecting the slurry tank to the surge tank such that waste slurry within the slurry tank overflows into the surge tank when the level of waste slurry within the slurry tank reaches a predetermined level.

14. A method for managing a waste produced from an animal confinement housing with a waste management system comprising:
flushing the waste from the animal confinement housing with a flushing material at a flush rate to produce a waste slurry including coarse solids;
reducing the particle size of the coarse solids of the waste slurry to produce a coarse solids-free waste slurry;
continuously recycling a portion of the waste slurry through the waste management system at a recycle rate of at least 95% of the flush rate whereby the waste slurry has a high concentration of solids; and
conditioning at least the recycled portion of the waste slurry to maintain air quality in the animal confinement housing.

15. A method as recited in claim 14, wherein the step of conditioning at least the recycled portion of the waste slurry comprises:
aerating at least the recycled portion of the waste slurry to prevent the formation of hydrogen sulfide; and
regulating the pH of at least the recycled portion of the waste slurry to prevent the emission of excess ammonia.

16. A method as recited in claim 14, wherein the step of reducing the particle size of the coarse solids of the waste slurry comprises chopping and grinding the waste slurry.
